(19) United States
(12) Patent Application Publication
(10) Pub. No.: US 2008/0139069 A1
(43) Pub. Date: Jun. 12, 2008

(54) SPUNBOND NON-WOVEN CONTAINING BAMBOO CHARCOAL AND METHOD FOR FABRICATING THE SAME

(75) Inventors: Sheng-Shan Chang, Taipei City (TW); Ta-Chuang An, Taipei County (TW); Wei-Jen Lai, Keelung City (TW); Yu-Chieh Chung, Yilan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: TAIWAN TEXTILE RESEARCH INSTITUTE, Taipei Hsien (TW)

(21) Appl. No.: 11/616,024

(22) Filed: Dec. 26, 2006

(30) Foreign Application Priority Data
Dec. 6, 2006 (TW) 95145363

(51) Int. Cl. D04H 3/16; B29C 63/00; D04H 3/00

(52) U.S. Cl. 442/362; 442/401; 442/361; 442/363; 442/364; 264/171.1

(57) ABSTRACT

A spunbond non-woven containing bamboo charcoal is provided, which has functions of thermal insulation, deodorization and acoustical absorption and including a plurality of non-woven fibers. The non-woven fibers include a bamboo charcoal mixture including bamboo charcoal and a polymer, wherein the bamboo charcoal accounts for 0.05˜35 wt % based on the total amount of the bamboo charcoal mixture. The present invention additionally provides a method for fabricating the single-component or multi-component spunbond non-woven containing bamboo charcoal. A bamboo charcoal grain containing bamboo charcoal is prepared, wherein the bamboo charcoal has an amount of 0.05˜35 wt % based on the total weight of the bamboo charcoal grain. Next, the bamboo charcoal grain or the bamboo charcoal grain mixed with a polymer is spunbond with another polymer by using a spin apparatus to form a non-woven.

### CROSS-REFERENCE TO RELATED APPLICATION

This application claims the priority benefit of Taiwan application serial no. 95145363, filed on Dec. 6, 2006. All disclosure of the Taiwan application is incorporated herein by reference.

### BACKGROUND OF THE INVENTION

1. Field of the Invention

The present invention relates to a non-woven and a method for fabricating the same, and more particularly, to a spunbond non-woven containing bamboo charcoal and a method for fabricating the same.

2. Description of Related Art

A non-woven is one of the applications of artificial fiber, having processes associated with techniques and principles of plastics, chemical engineering, papermaking and textiles and so on. As a result of the fabrication without such conventional means as plain weave or knitting, this application of artificial fiber is called as the non-woven. The non-woven is endowed with such properties as light weight, flexibility, low thermal conductibility, good gas permeability, hygroscopicity, humectation, dust-proof, high speed and low cost in fabrication, and antistatic. Accordingly, it is extremely widely used, and used in various industries, such as agriculture, construction, people's livelihood, industry, pharmacy, automobile, as material having functions of filtration, isolation and hygroscopicity.

In recent years, a method for fabricating the non-woven in a spunbonding process has been developed, for example, as disclosed in U.S. Pat. No. 6,830,809, U.S. Pat. No. 6,802,873, and U.S. Pat. No. 5,783,503, which has the advantages of high speed and large throughput over traditional fabrication processes and the non-wovens fabricated are endowed with desirable mechanical strength. Therefore, it is the trend of textile industry in the future to fabricate the non-woven in the spunbond process. However, techniques associated with the spunbond non-woven are freshly developed in the last few years, thus the functions of most spunbond non-woven is still less. While nowadays there exist more and more demands in functions of the spunbond non-woven fiber, such as thermal insulation, deodorization, and acoustical absorption. Therefore, if the non-woven having the foregoing functions can be created, it will be of huge market potential.

There are applications of a number of textiles with addition of the bamboo charcoal ingredient in current market, and the prior arts related to bamboo charcoal includes Chinese Patents 200310110113.9, 200420089929.8, 200420107743.0, 200510001746.5 and 200320121157.7; Taiwan Patent M275790; and Japanese Patent Laid-open 2003-135237. Since bamboo charcoal is endowed with functions of thermal insulation, deodorization, and acoustical absorption and so on, addition of bamboo charcoal into the textiles would endow the textile with functions of thermal insulation, deodorization, acoustical absorption and so on. However, all the current methods for adding bamboo charcoal into the textiles involves direct coating or mixing bamboo charcoal powders or particles into the textiles. Accordingly, it has not yet been proposed to apply bamboo charcoal in the spunbond non-woven.

### SUMMARY OF THE INVENTION

Accordingly, the present invention is directed to provide a spunbond non-woven containing bamboo charcoal having thermal insulation, deodorization, acoustical absorption and other functions.

The present invention provides a method for fabricating a multi-component or single-component spunbond non-woven containing bamboo charcoal, wherein the non-wovens made according to this method have thermal insulation, deodorization, acoustical absorption and other functions.

The present invention provides a spunbond non-woven containing bamboo charcoal formed by spunbonding a plurality of non-woven fibers, wherein the non-woven fibers comprise a bamboo charcoal mixture comprising bamboo charcoal and a polymer, wherein the bamboo charcoal accounts for 0.05˜35 wt % based on a total amount of the bamboo charcoal mixture.

In one embodiment according to the present invention, the foregoing bamboo charcoal has a far-infrared emissivity greater than 0.8.

In an embodiment according to the present invention, the foregoing polymer is selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

In an embodiment according to the present invention, the foregoing non-woven has a cross-sectional shape selected from circle, ellipse, strip, triangle, square, rectangle, annularity, polygon or a combination thereof.

In an embodiment according to the present invention, the foregoing non-woven further comprises another or more polymer such that the another or more polymer and the bamboo charcoal mixture form a multi-component non-woven fiber.

In an embodiment according to the present invention, the another or more polymer is selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

In an embodiment according to the present invention, the foregoing multi-component non-woven has a cross-sectional pattern selected from segmentation, hollow segmentation, core sheath, hollow core sheath, island, side-by-side, and combinations thereof.

In an embodiment according to the present invention, the foregoing non-woven fiber further comprises at least one additive including nano-clay, nano-gold, nano-silver, nano-zinc or a combination thereof.

In an embodiment according to the present invention, the foregoing spunbond non-woven containing bamboo charcoal has a temperature rising value between 1 to 40 Celsius degrees upon irradiation by a heat source, and the temperature at 5 minutes after removing the heat source is 0.2˜22 Celsius degrees higher than that without being irradiated by the heat source.

In an embodiment according to the present invention, the foregoing spunbond non-woven containing bamboo charcoal has a deodorization efficiency greater than 40%.

In an embodiment according to the present invention, the foregoing spunbond non-woven containing bamboo charcoal has an acoustic absorptivity greater than 50%.

In an embodiment according to the present invention, a part of the fibers in the foregoing spunbond non-woven containing bamboo charcoal is the bamboo charcoal mixture, and another part of the fibers is a mixture free of the bamboo charcoal.

In an embodiment according to the present invention, the content of the bamboo charcoal mixture of a part of the fibers in the foregoing spunbond non-woven containing bamboo charcoal is different from that of another part of the fibers.

The present invention additionally provides a method for fabricating a multi-component spunbond non-woven containing bamboo charcoal. A bamboo charcoal grain containing bamboo charcoal is prepared, wherein the bamboo charcoal has an amount of 0.05˜35 wt % based on the total weight of the bamboo charcoal grain. Next, the bamboo charcoal grain is spunbond with a first polymer by using a spin apparatus to form a non-woven.

In an embodiment according to the present invention, the method further comprises mixing the bamboo charcoal grain with a second polymer before spunbonding the bamboo charcoal grain with the first polymer.

In an embodiment according to the present invention, the first and second polymer described above are respectively selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

In an embodiment according to the present invention, the method further comprises performing a squirt cut process or water jets process, a needle-bonding process, a thermal compression process, an adhesion process or a combination thereof after spunbonding the bamboo charcoal grain with the first polymer by using the spinning apparatus to form a non-woven.

In an embodiment according to the present invention, the foregoing bamboo charcoal grain further comprises at least one additive including nano-clay, nano-gold, nano-silver, nano-zinc or a combination thereof.

In an embodiment according to the present invention, the foregoing non-woven has a cross-sectional shape selected from circle, strip, triangle, annularity, ellipse, square, rectangle, polygon or a combination thereof.

In an embodiment according to the present invention, the foregoing multi-component non-woven has a cross-sectional pattern selected from segmentation, hollow segmentation, core sheath, hollow core sheath, island, side-by-side or a combination thereof.

The present invention additionally provides a method for fabricating a single-component spunbond non-woven containing bamboo charcoal. A bamboo charcoal grain containing bamboo charcoal is prepared, wherein the bamboo charcoal has an amount of 0.05˜35 wt % based on the total weight of the bamboo charcoal grain. Next, the bamboo charcoal grain is spunbond by using a spin apparatus to form a non-woven.

In an embodiment according to the present invention, the method further comprises performing a squirt cut process or water jets process, a needle-bonding process, a thermal compression process, an adhesion process or a combination thereof after spunbonding the bamboo charcoal grain by using the spinning apparatus to form the non-woven.

In an embodiment according to the present invention, the foregoing polymer is selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

In an embodiment according to the present invention, the foregoing bamboo charcoal grain further comprises at least one additive including nano-clay, nano-gold, nano-silver, nano-zinc or a combination thereof.

In an embodiment according to the present invention, the foregoing non-woven has a cross-sectional shape selected from circle, strip, triangle, annularity, ellipse, square, rectangle, polygon or a combination thereof.

The present invention involves using the bamboo charcoal to fabricate the non-woven in a spunbonding process, wherein as a result of bamboo charcoal itself having thermal insulation, deodorization, acoustical absorption and other functions, the non-woven produced has thermal insulation, deodorization, acoustical absorption and other effects.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an apparatus for fabricating a spunbond non-woven containing bamboo charcoal according to an embodiment of the present invention.

FIG. 2A to FIG. 2H show the cross-sectional shapes of the non-woven fibers according to the embodiments of the present invention.

FIG. 3A to FIG. 3L show the cross-sectional patterns of the double-component non-woven fibers according to the embodiments of the present invention.

FIG. 4 is a cross-sectional view of the non-woven fibers according to the embodiments of the present invention.

### DESCRIPTION OF EMBODIMENTS

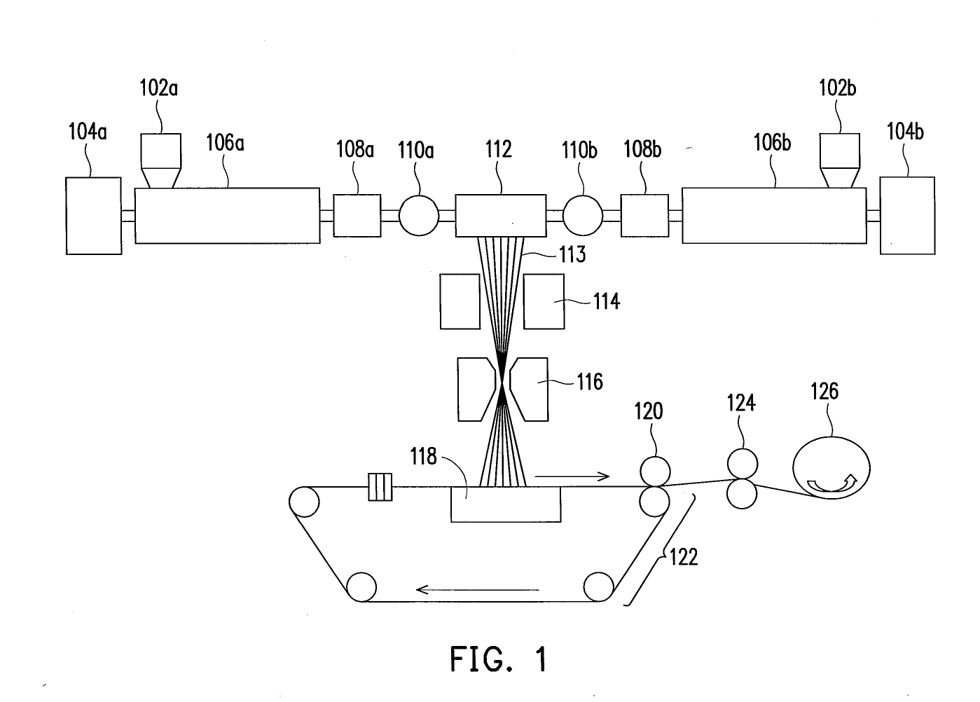

FIG. 1 is a schematic view of an apparatus for fabricating a spunbond non-woven containing bamboo charcoal according to an embodiment of the present invention. The following description is illustrated by an example of fabricating a double-component spunbond non-woven containing bamboo charcoal, however the present invention is not limited to this description. Referring to FIG. 1, this apparatus includes a feeding hopper 102a and 102b, an extruder drive 104a and 104b, an extruder 106a and 106b, a filter 108a and 108b, a pump 110a and 110b, a spin pack 112, a quench gas supply 114, an attenuation 116, a platform 118, a conveyor 122, a compaction device 120, a calender 124, and a winder 126.

The method for fabricating this double-component spunbond non-woven containing bamboo charcoal begins with the preparation of a bamboo charcoal grain. In particular, the ingredients in the bamboo charcoal grain comprise bamboo charcoal and a polymer, wherein bamboo charcoal has an amount of 0.05˜35 wt % of the bamboo charcoal grain. In an embodiment, the bamboo charcoal has a far-infrared emissivity greater than 0.8. In addition, the polymer in the bamboo charcoal grain is, for example, selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof. Certainly, the foregoing bamboo charcoal grain can further comprise at least one additive, for example nano-clay, nano-gold, nano-silver, nano-zinc or a combination thereof.

In addition, another polymer is prepared, of which the material is for example selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof. In other words, the material of the polymer may be same as or different from the ingredient of the polymer in the bamboo charcoal grain.

Thereafter, the ready-made bamboo charcoal grain and the polymer are spunbond by using the apparatus as shown in FIG. 1 to form a non-woven, as described in detail below. Firstly, the bamboo charcoal grain and the polymer are charged into the feeding hopper 102a and 102b, respectively. In another embodiment, the bamboo charcoal grain may be mixed with another polymer before charging into the feeding hopper 102a, of which the material is also selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

Subsequently, the bamboo charcoal grain and polymer are heated to fusion by the extruder drive 104a and 104b and the extruder 106a and 106b, and extruded to the spinning device 112. During this period, the bamboo charcoal grain and polymer will pass through the filter 108a and 108b, and reach the spin pack 112 with the propel of pump 110a and 110b. Upon the bamboo charcoal grain and polymer entering into the spin pack 112, the non-woven fibers 113 are formed by the spin pack 112, and laid on the platform 118 to form a non-woven. In an embodiment, after the non-woven fiber 113 is formed by spinning of the spin pack 112, it is quenched and cured by the quench gas supply 114, and then is attenuated by the attenuation 116. Subsequently, the non-woven on the platform 118 is transferred by the conveyor 122 toward the winder 126. During the period transferring to the winder 126, the non-woven may be treated by other post-processes, for example a squirt cut process or water jets process, a needle-bonding process, a thermal compression process, an adhesion process, or combinations thereof, to enhance the mechanical strength of the non-woven. But in the figure only the compaction device 120 (i.e. the thermal compression process) and the calender 124 are shown as example for illustration.

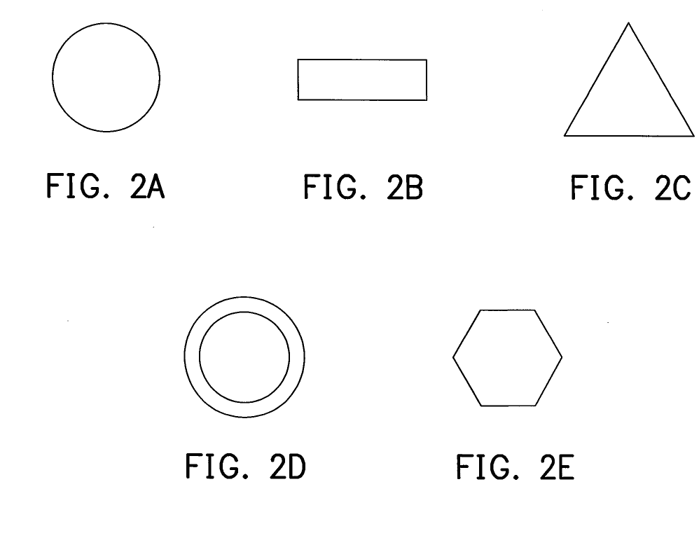

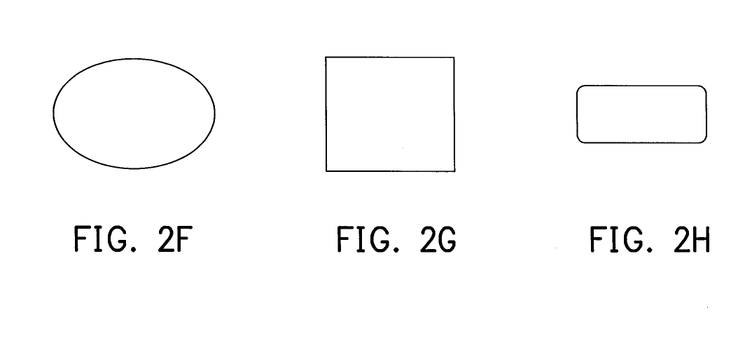

Therefore, the double-component spunbond non-woven containing bamboo charcoal formed by using the foregoing apparatus is formed by spunbonding a plurality of the non-woven fibers, and the non-woven fibers are the double-component fibers comprised of the bamboo charcoal mixture (from the bamboo charcoal grain) and the polymer. The cross-sectional shape of the non-woven fibers may be selected from circle (as shown in FIG. 2A), rectangle (as shown in FIG. 2B), triangle (as shown in FIG. 2C), annularity (as shown in FIG. 2D), polygon (as shown in FIG. 2E), ellipse (as shown in FIG. 2F), square (as shown in FIG. 2G), strip (as shown in FIG. 2H), other shapes, or a combination thereof.

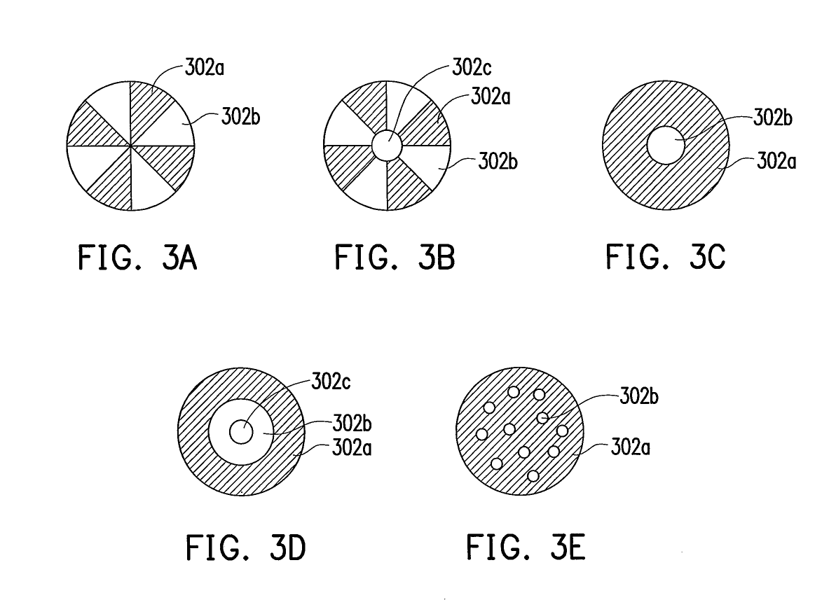

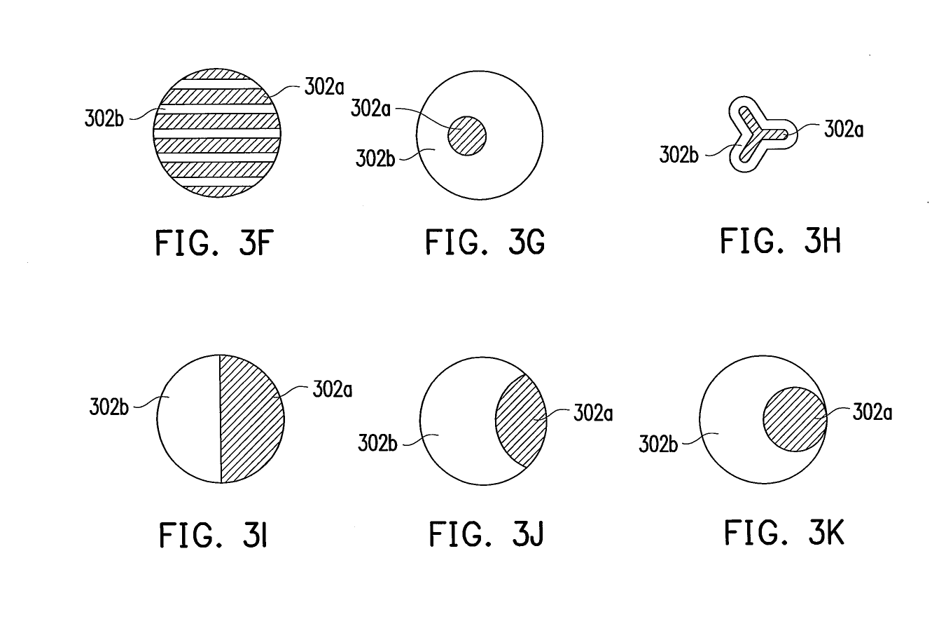

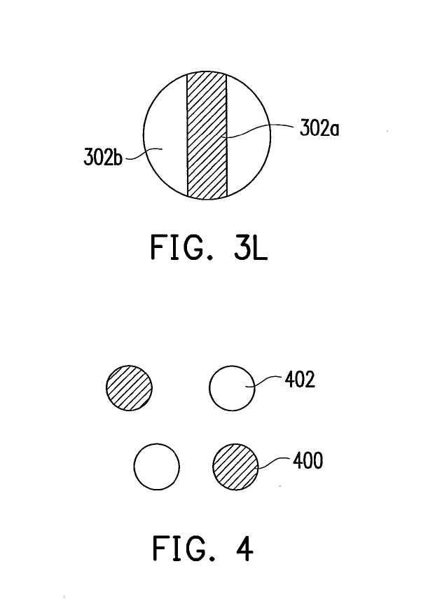

The cross-sectional pattern of the double-component non-woven fiber formed according to the foregoing processes may be selected from segmentation (as shown in FIG. 3A, 3F), hollow segmentation (as shown in FIG. 3B), core sheath (as shown in FIG. 3C, 3G, 3H), hollow core sheath (as shown in FIG. 3D), island (as shown in FIG. 3E), side-by-side (as shown in FIG. 3I, 3J, 3K, 3L) or a combination thereof. In an embodiment, in the foregoing FIG. 3A to FIG. 3L, reference number 302a denotes the bamboo charcoal mixture ingredient in the fiber, reference number 302b denotes the polymer ingredient in the fibers, and reference number 302c denotes hollow. In another embodiment, reference number 302a denotes the part comprising the first bamboo charcoal mixture in the fibers, reference number 302b denotes the part comprising the second bamboo charcoal mixture in the fibers, wherein the content of bamboo charcoal in the first bamboo charcoal mixture is different from that in the second bamboo charcoal mixture. In addition, the segmentation pattern shown in FIG. 3A is 8-segmentation form, but the present invention is not limited to this pattern, and also may be 2-segmentation, 4-segmentation, 16-segmentation, 32-segmentation, 64-segmentation or 128-segmentation, and so on.

The embodiments described above are illustrated by an example of the double-component spunbond non-woven containing bamboo charcoal, but the present invention is not limited to the embodiments. The single-component or multi-component spunbond non-woven containing bamboo charcoal can be produced according to the present invention. Taking the single-component spunbond non-woven containing bamboo charcoal as example, the method for fabricating the same may involve preparing bamboo charcoal grain as described above or premixing the bamboo charcoal grain with another polymer. Similarly, this bamboo charcoal grain may also comprise an additive. Thereafter, the bamboo charcoal grains or the bamboo charcoal grains blended with another polymer pass through the spin pack to form the non-woven. Likewise, the cross-sectional shape of the fibers forming the non-woven may be one of circle, strip, triangle, annularity, polygon, ellipse, square or rectangle, and combination thereof (as shown in FIG. 2A to FIG. 2H).

Moreover, in addition to the foregoing single-component and double-component spunbond non-woven containing bamboo charcoal, the present invention also provides the multi-component spunbond non-woven containing bamboo charcoal, for example, three-component or four-component spunbond non-woven containing bamboo charcoal. In each fiber in the multi-component bamboo charcoal non-woven, at least one ingredient comprises bamboo charcoal. For example, taking the three-component spunbond non-woven containing bamboo charcoal as example, the first component may be a bamboo charcoal mixture, the second component may be a first polymer, and the third component may be a second polymer. Certainly, the first component may be a bamboo charcoal mixture, the second component may be a second bamboo charcoal mixture, and the third component may be a polymer. In addition, in the present invention, it is not limited that each fiber of the spunbond non-woven contains the bamboo charcoal ingredient, that is, in the spunbond non-woven, a part of the fibers comprise a bamboo charcoal ingredient, and another part is a single polymer ingredient without the bamboo charcoal component, as shown in FIG. 4.

Since the spunbond non-woven containing bamboo charcoal according to the present invention comprise a bamboo charcoal ingredient, this spunbond non-woven containing bamboo charcoal has thermal insulation, deodorization, acoustical absorption and other functions. If an additive (for example nano-clay, nano-gold, nano-silver, nano-zinc, or combinations thereof) is added into the bamboo charcoal grain, the finally produced spunbond non-woven containing bamboo charcoal, in addition to functions of thermal insulation, deodorization and acoustical absorption, also has antibacterial and/or fire-proof functions, depending on the functions of the additive added.

The functions of thermal insulation, deodorization and acoustical absorption possessed by the bamboo charcoal non-woven according to the present invention will be described as follows.

### Thermal Insulation

The thermal insulation test on the spunbond non-woven containing bamboo charcoal according to the present invention involves irradiating the bamboo charcoal non-woven by a heat source, wherein a distance between the heat source and the non-woven is 50 centimeter, and the non-woven is of two layers. Upon irradiation by the heat source, the temperature rising value of the bamboo charcoal non-woven may reach 1˜40 Celsius degrees. In addition, when measuring the temperature of the bamboo charcoal non-woven at 5 minutes after removing the heat source, the temperature is 0.2˜22 Celsius degrees higher than that without being irradiated the heat source. Therefore, it is proved that the bamboo charcoal non-woven according to the present invention have thermal insulation function.

### Deodorization

The deodorization test on the spunbond non-woven containing bamboo charcoal according to the present invention involves performing the detection by a deodorization process according to JAFET of Japan. The detection results indicate that the deodorization efficiency of the spunbond non-woven containing bamboo charcoal according to the present invention is greater than 40%. In particular, if acetic acid is used as an odorous source, the deodorization efficiency may be up to 54%. Because the bamboo charcoal ingredient in the spunbond non-woven containing bamboo charcoal has a chemical adsorption effect on acetic acid; the bamboo charcoal non-woven according to the present invention has favorable deodorization efficiency. Certainly, the bamboo charcoal non-woven according to the present invention may also have deodorization effect on other odorous sources.

### Acoustical Absorption

The acoustical absorption test on the spunbond non-woven containing bamboo charcoal according to the present invention involves performing the test by the ASTM E1050 process. The test results indicate that the acoustic absorptivity of the spunbond non-woven containing bamboo charcoal according to the present invention is greater than 50%, even up to 68%.

As a result of the spunbond non-woven containing bamboo charcoal according to the present invention comprising the bamboo charcoal component, it has effects of thermal insulation, deodorization and acoustical absorption, even antibacterial effect. And the spunbond non-woven containing bamboo charcoal according to the present invention may be applied in textiles for clothing, health care, home decoration, bedding, window curtain, interior of automobile and so on, thus having a considerable market value.

Although the present invention is disclosed as above with preferable embodiments, however, it is not limited to the disclosure of the embodiments, and it will be apparent to those skilled in the art that various alternations and modifications can be made without departing from the scope or spirit of the invention. Therefore, the protection scope of the present invention depends on those defined by the scope of the following claims.

What is claimed is:

1. A spunbond non-woven containing bamboo charcoal, formed by spunbonding a plurality of non-woven fibers, the non-woven fibers comprising:
a bamboo charcoal mixture comprising bamboo charcoal and a polymer, wherein the bamboo charcoal accounts for 0.05˜35 wt % based on the total amount of the bamboo charcoal mixture.

2. The spunbond non-woven containing bamboo charcoal as claimed in claim 1, wherein the bamboo charcoal has a far-infrared emissivity greater than 0.8.

3. The spunbond non-woven containing bamboo charcoal as claimed in claim 1, wherein the polymer is selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

4. The spunbond non-woven containing bamboo charcoal as claimed in claim 1, wherein the non-woven fibers have a cross-sectional shape selected from one of the circle, strip, triangle, annularity, ellipse, square, rectangle, polygon and a combination thereof.

5. The spunbond non-woven containing bamboo charcoal as claimed in claim 1, further comprising another or more polymer, such that the another or more polymer and the bamboo charcoal mixture form a multi-component non-woven fiber.

6. The spunbond non-woven containing bamboo charcoal as claimed in claim 5, wherein the another or more polymer is selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

7. The spunbond non-woven containing bamboo charcoal as claimed in claim 5, wherein the multi-component non-woven fibers have a cross-sectional pattern selected from segmentation, hollow segmentation, core sheath, hollow core sheath, island, side-by-side or a combination thereof.

8. The spunbond non-woven containing bamboo charcoal claimed as claim 1, further comprising at least one additive including nano-clay, nano-gold, nano-silver, nano-zinc or a combination thereof.

9. The spunbond non-woven containing bamboo charcoal claimed as claim 1, wherein the spunbond non-woven containing bamboo charcoal has a temperature rising value between 1 to 40 Celsius degree upon irradiation by a heat source, and the temperature at 5 minutes after removing the heat source is 0.2˜22 Celsius degrees higher than that without being irradiated by the heat source.

10. The spunbond non-woven containing bamboo charcoal as claimed in claim 1, wherein the spunbond non-woven containing bamboo charcoal has a deodorization efficiency greater than 40%.

11. The spunbond non-woven containing bamboo charcoal as claimed in claim 1, wherein the spunbond non-woven containing bamboo charcoal has an acoustic absorptivity greater than 50%.

12. The spunbond non-woven containing bamboo charcoal claimed in claim 1, wherein a part of the fibers in the spunbond non-woven containing bamboo charcoal is the bamboo charcoal mixture, and another part of the fibers is a mixture free of bamboo charcoal.

13. The spunbond non-woven containing bamboo charcoal claimed in claim 1, wherein the content of the bamboo charcoal mixture of a part of the fibers in the spunbond non-woven containing bamboo charcoal is different from that of another part of the fibers.

14. A method for fabricating a multi-component spunbond non-woven containing bamboo charcoal, comprising:
preparing a bamboo charcoal grain comprising bamboo charcoal and a polymer, wherein the bamboo charcoal accounts for 0.05˜35 wt % of the bamboo charcoal grain; and
spunbonding the bamboo charcoal grain with a first polymer by using a spinning apparatus to form a non-woven.

15. The method for fabricating a multi-component spunbond non-woven containing bamboo charcoal claimed in claim 14, further comprising mixing the bamboo charcoal grain with a second polymer before spunbonding the bamboo charcoal grain with the first polymer.

16. The method for fabricating a multi-component spunbond non-woven containing bamboo charcoal as claimed in claim 15, wherein the first polymer, the second polymer, and the polymer in the bamboo charcoal grain are respectively selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

17. The method for fabricating a multi-component spunbond non-woven containing bamboo charcoal as claimed in claim 14, further comprising performing a squirt cut process or water jets process, a needle-bonding process, a thermal compression process, an adhesion process, or a combination thereof for the non-woven after spunbonding the bamboo charcoal grain with the first polymer to form the non-woven by using the spinning apparatus.

18. The method for fabricating a multi-component spunbond non-woven containing bamboo charcoal claimed in claim 14, wherein the bamboo charcoal grain further comprises at least one additive comprising nano-clay, nano-gold, nano-silver, nano-zinc or a combination thereof.

19. The method for fabricating a multi-component spunbond non-woven containing bamboo charcoal claimed in claim 14, wherein the non-woven fibers have a cross-sectional shape selected from circle, strip, triangle, annularity, ellipse, square, rectangle, polygon or a combination thereof.

20. The method for fabricating a multi-component spunbond non-woven containing bamboo charcoal as claimed in claim 14, wherein the multi-component non-woven fiber have a cross-sectional pattern selected from segmentation, hollow segmentation, core sheath, hollow core sheath, island, side-by-side or a combination thereof.

21. A method for fabricating a single-component spunbond non-woven containing bamboo charcoal, comprising:
preparing a bamboo charcoal grain comprising bamboo charcoal and a polymer, and the bamboo charcoal accounts for 0.05˜35 wt % of the bamboo charcoal grain; and
spunbonding the bamboo charcoal grain by using a spinning apparatus to form a non-woven.

22. The method for fabricating a single-component spunbond non-woven containing bamboo charcoal as claimed in claim 21, further comprising performing a squirt cut process or water jets process, a needle-bonding process, a thermal compression process, an adhesion process or a combination thereof for the non-woven after spunbonding the bamboo charcoal grain to form the non-woven by using the spinning apparatus.

23. The method for fabricating a single-component spunbond non-woven containing bamboo charcoal as claimed in claim 21, wherein the polymer is selected from polyethylene, polypropylene, polyethylene glycol, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyethylene oxide and polyester, nylon, polylactic acid, polyvinylalcohol (PVA), poly-propylene terephthalate (PPT), polybutylene terephthalate (PBT) or a combination thereof.

24. The method for fabricating a single-component spunbond non-woven containing bamboo charcoal claimed in claim 21, wherein the bamboo charcoal grain further comprises at least one additive including nano-clay, nano-gold, nano-silver, nano-zinc or a combination thereof.

25. The method for fabricating a single-component spunbond non-woven containing bamboo charcoal claimed in claim 21, wherein the non-woven fibers have a cross-sectional shape selected from circle, strip, triangle, annularity, ellipse, square, rectangle, polygon or a combination thereof.
